(19) United States
(12) Patent Application Publication
(10) Pub. No.: US 2018/0025276 A1
(43) Pub. Date: Jan. 25, 2018

(54) System for Managing Effective Self-Service Analytic Workflows

(71) Applicant: Dell Software, Inc., Round Rock, TX (US)

(72) Inventors: Thomas Hill, Tulsa, OK (US); George R. Butler, Tulsa, OK (US); Vladimir S. Rastunkov, Tulsa, OK (US)

(73) Assignee: Dell Software, Inc., Round Rock, TX (US)

(21) Appl. No.: 15/214,622

(22) Filed: Jul. 20, 2016

(51) Int. Cl. G06N 5/02; G06F 3/0482; G06F 3/0481; G06F 3/0484

(52) U.S. Cl. CPC G06N 5/022; G06F 3/04842; G06F 3/0482; G06F 3/04817

(57) ABSTRACT

A system, method, and computer-readable medium for performing an analytics workflow generation operation. The analytics workflow generation operation enables generation of targeted analytics workflows (e.g., via a data scientist (i.e., an expert in data modeling)) that are then published to a workflow storage repository so that the targeted analytics workflows can be used by domain experts and self-service business end-users to solve specific classes of analytics operations.

### BACKGROUND OF THE INVENTION

### Field of the Invention

The present invention relates to information handling systems. More specifically, embodiments of the invention relate to managing effective self-service analytic workflows.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to use information handling systems to collect and store large amounts of data. Many technologies are being developed to process large data sets (often referred to as “big data,” and defined as an amount of data that is larger than what can be copied in its entirety from the storage location to another computing device for processing within time limits acceptable for timely operation of an application using the data).

In-database predictive analytics have become increasingly relevant and important to address big-data analytic problems. When the amount of data that need be processed to perform the computations required to fit a predictive model become so large that it is too time-consuming to move the data to the analytic processor or server, then the computations must be moved to the data, i.e., to the data storage server and database. Because modern big-data storage platforms typically store data across distributed nodes, the computations often must be distributed also. I.e., the computations often need be implemented in a manner that data-processing intensive computations are performed on the data at each node, so that data need not be moved to a separate computational engine or node. For example, the Hadoop distributed storage framework includes well-known map-reduce implementations of many simple computational algorithms (e.g., for computing sums or other aggregate statistics).

One issue that relates to predictive analytics is how to make advanced predictive analytics tools available to business end-users who may be experts in their domain, but possess limited expertise in data science, statistics, or predictive modeling. A known approach to this issue is to provide end-users an analytic tool with very few options to solve a variety of predictive modeling challenges. This approach identifies generic (or simple) analytic workflows that can automate the analytic process of data exploration, preparation, modeling, model evaluation and validation, and deployment. However, an issue with such tools is that the tools tend to produce sometimes unacceptable and almost always generally low-quality results.

In general, it is known that the more targeted and specialized an analytic workflow is with respect to the particular nature of the data and analytic problems to be solved, the better the model and the greater the return on investment (ROI). This is one reason why data scientists are often needed to perform targeted and/or specialized predictive analytics operations such as predictive modeling. Accordingly, it would be desirable to simplify predictive analytics operation such as predictive analytics to make predictive modeling easier for self-service domain experts with limited data science or predictive modeling experience, i.e., to enable more effectively the “citizen data scientist.”

### SUMMARY OF THE INVENTION

A system, method, and computer-readable medium are disclosed for performing an analytics workflow generation operation. The analytics workflow generation operation enables generation of targeted analytics workflows (e.g., created by a data scientist (i.e., an expert in data modeling)) that are then published to a workflow storage repository so that the targeted analytics workflows can be used by domain experts and self-service business end-users to solve specific classes of analytics operations.

More specifically, in certain embodiments, an analytics workflow generation system provides a user interface for data modelers and data scientists to generate parameterized analytic templates. In certain embodiments, the parameterized analytic templates include one or more of data preparation, data modeling, model evaluation, and model deployment steps specifically optimized for a particular domain and data sets of interest. In certain embodiments, the user interface to create analytic workflows is flexible to permit data scientists to select data management and analytical tools from a comprehensive palette, to parameterize analytic workflows, to provide the self-service business users the necessary flexibility to address the particular challenges and goals of their analyses, without having to understand the details and theoretical justifications for a specific sequence of specific data preparation and modeling tasks.

In certain embodiments, the analytics workflow generation system provides self-service analytic user interfaces (such as web-based user interfaces) so that self-service users can choose the analytic workflow templates to solve their specific analytic problems. In certain embodiments, when providing the self-service analytic user interfaces, the system analytics workflow generation accommodates role-based authentication so that particular groups of self-service users have access to the relevant templates to solve the analytic problems in their domain. In certain embodiments, the analytics workflow generation system allows self-service users to create defaults for parameterizations, and to configure certain aspects of the workflows as designed for (and allowed by) the data scientist creators of the workflows. In certain embodiments, the analytics workflow generation system allows self-service users to share their configurations with other self-service users in their group, to advance best-practices with respect to the particular analytic problems under consideration by the particular customer.

In certain embodiments, the analytics workflow generation system manages two facets of data modeling, a data scientist facet and a self-service end-user facet. More specifically, the data scientist facet allows experts (such as data scientist experts) to design data analysis flows for particular classes of problems. As and when needed experts define automation layers for resolving data quality issues, variable selection, best model or ensemble selection. This automation is applied behind the scenes when the citizen-data-scientist facet is used. The self-service end-user or citizen-data-scientist facet then enables the self-service end-users to work with the analytic flows and to apply specific parameterizations to solve their specific analytic problems in their domain.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of an environment for analytics workflow generation.

FIG. 3 shows a block diagram of data scientist facet an analytics workflow generation system.

FIG. 4 shows a block diagram of an end-user facet of the analytics workflow generation system.

FIG. 5 shows an example screen presentation of an expert data scientist user interface.

FIG. 6 shows an example screen presentation of a self-service end-user user interface.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

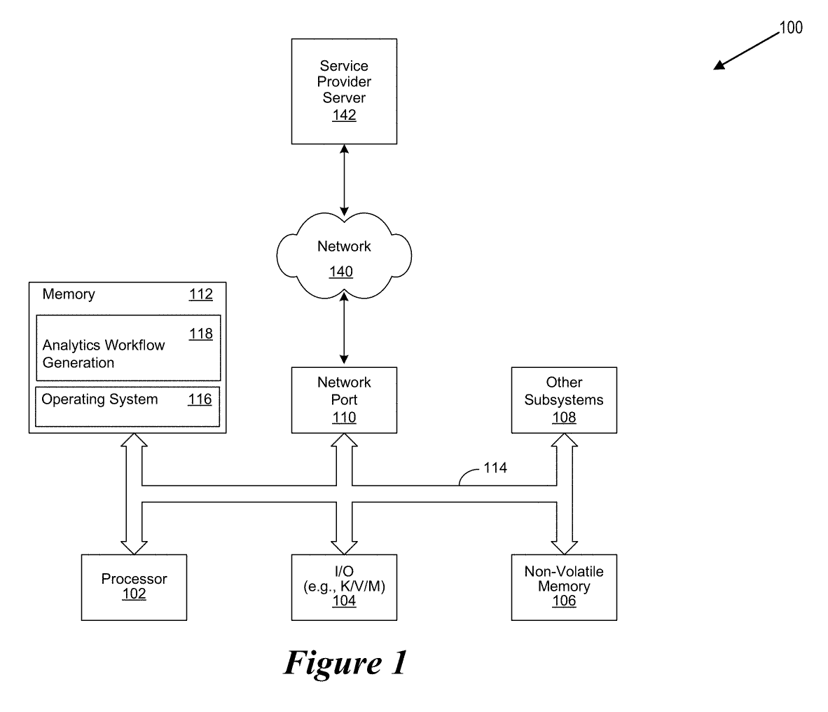

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise an analytics workflow generation system 118.

The analytics workflow generation system 118 performs an analytics workflow generation operation. The analytics workflow generation operation enables generation of targeted analytics workflows created by one or more data scientists, i.e., experts in data modeling who are trained in and experienced in the application of mathematical, statistical, software and database engineering, and machine learning principles, as well as the algorithms, best practices, and approaches for solving data preparation, integration with database management systems as well as file systems and storage solutions, modeling, model evaluation, and model validation problems as they typically occur in real-world applications. These analytics workflows are then published to a workflow storage repository so that the targeted analytics workflows can be used by domain experts and self-service business end-users to solve specific classes of analytics operations.

More specifically, in certain embodiments, an analytics workflow generation system 118 provides a user interface for data modelers and data scientists to generate parameterized analytic templates. In certain embodiments, the parameterized analytic templates include one or more of data preparation, data modeling, model evaluation, and model deployment steps specifically optimized for a particular domain and data sets of interest. For example, a particular business such as an insurance company may employ data-scientist-experts as well as internal citizen-data-scientist customers for those expert-data-scientists who may perform specific repeated data pre-processing and modeling tasks on typical data files and their specific esoteric data preparation and modeling requirements. Using the analytics workflow generation system 118, a data scientist expert could publish templates to address specific business problems with typical data files for the customer (e.g., actuaries), and make the templates available to the customer to solve analytic problems specific to the customer, while shielding the customer from common data preparation as well as predictor and model selection tasks. In certain embodiments, the user interface to create analytic workflows is flexible to permit data scientists to select data management and analytical tools from a comprehensive palette, to parameterize analytic workflows, to provide the self-service business users the necessary flexibility to address the particular challenges and goals of their analyses, without having to understand data preparation and modeling tasks.

Next, in certain embodiments, the analytics workflow generation system 118 provides self-service analytic user interfaces (such as web-based user interfaces) so that self-service users can choose the analytic workflow templates to solve their specific analytic problems. In certain embodiments, when providing the self-service analytic user interfaces, the system 118 analytics workflow generation accommodates role-based authentication so that particular groups of self-service users have access to the relevant templates to solve the analytic problems in their domain. In certain embodiments, the analytics workflow generation system 118 allows self-service users to create defaults for parameterizations, and to configure certain aspects of the workflows as designed for (and allowed by) the data scientist creators of the workflows. In certain embodiments, the analytics workflow generation system 118 allows self-service users to share their configurations with other self-service users in their group, to advance best-practices with respect to the particular analytic problems under consideration by the particular customer.

In certain embodiments, the analytics workflow generation system 118 manages two facets of data modeling, a data scientist facet and a self-service end-user facet. More specifically, the data scientist facet allows experts (such as data scientist experts) to design data analysis flows for particular classes of problems. As and when needed experts define automation layers for resolving data quality issues, variable selection, best model or ensemble selection. This automation is applied behind the scenes when the citizen-data-scientist facet is used. The self-service end-user or citizen-data-scientist facet then enables the self-service end-users to work with the analytic flows and to apply specific parameterizations to solve their specific analytic problems in their domain.

Thus, the analytics workflow generation system 118 enables high-quality predictive modeling by providing expert data scientists the ability to design “robots-that-design-robots,” i.e., templates that solve specific classes of problems for domain expert citizen-data scientists in the field. Such an analytics workflow generation system 118 is applicable to manufacturing, insurance, banking, and practically all customers of an analytics system 118 such as the Dell Statistica Enterprise Analytics System. It will be appreciated that certain analytics system can provide the architectures for role-based shared analytics. Such an analytics workflow generation system 118 addresses the issue of simplifying and accelerating predictive modeling for citizen data scientists, without compromising the quality and transparency of the models. Additionally, such an analytics workflow generation system 118 enables more effective use of data scientists by a particular customer.

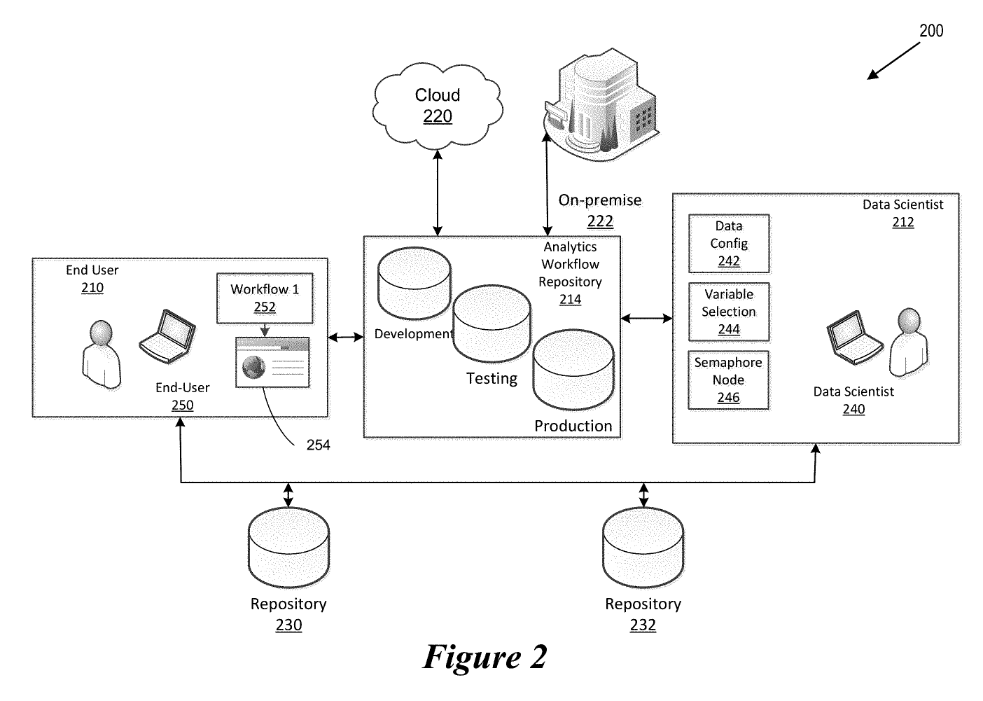

FIG. 2 shows a block diagram of an environment 200 for performing analytics workflow generation operations. More specifically, the analytics workflow generation environment 200 includes an end-user module 210, a data scientist module 212 and an analytics workflow storage repository 214. The analytics workflow storage repository 214 may be stored remotely (e.g., in the cloud 220) or on premises 222 of a particular customer. In certain embodiments, the analytics workflow storage repository may include a development repository, a testing repository and a production repository, some or all of which may be stored in separate physical storage repositories. The environment further includes one or more data repositories 230 and 232. In certain embodiments, one of the aspects of the analytics workflow generation environment 200 is that a single published workflow template can access and integrate multiple data sources, e.g., weather data from the web, Sales Force data form the cloud, on-premise RDBMS data, and/or noSQL data somewhere (e.g., in AWS). The end-user can be completely shielded from complexities associated with accessing and integrating multiple data sources.

The data repositories 230 and 232 may be configured to perform distributed computations to derive suitable aggregate summary statistics, such as summations, multiplications, and derivation of new variables via formulae. In various embodiments, either or all of the data repositories 230 and 232 comprises a SQL Server, an Oracle type storage system, an Apache Hive type storage system, an Apache Spark and/or a Teradata Server. It will be appreciated that other database platforms and systems are within the scope of the invention. It will also be appreciated that the data repositories can comprise a plurality of databases which may or may not be the same type of database.

In certain embodiments, one or both the end-user module 210 and the data scientist module 212 include a respective analytics system which performs statistical and mathematical computations. In certain embodiments, the analytics system comprises a Statistica Analytics System available from Dell, Inc. The analytics system performs mathematical and statistical computations to derive final predictive models.

Additionally, in certain embodiments, the execution performed on the data repository includes performing certain computations and then creating subsamples of the results of the execution on the data repository. The analytics system can then operate on subsamples to compute (iteratively, e.g., over consecutive samples) final predictive models. Additionally, in certain embodiments, the subsamples are further processed to compute predictive models including recursive partitioning models (trees, boosted trees, random forests), support vector machines, neural networks, and others.

In this process, consecutive samples may be random samples extracted at the data repository, or samples of consecutive observations returned by queries executing in the data repository. The analytics system computes and refines desired coefficients for predictive models from consecutively returned samples, until the computations of consecutive samples no longer lead to modifications of those coefficients. In this manner, not all data in the data repository ever needs to be processed.

The data scientist module 212 provides an extensive set of options available for the analyses and data preparation nodes. When performing an analytics workflow generation operation a data scientist 240 can leverage creation of customized nodes for data preparation and analysis using any one of a plurality of programming languages. In certain embodiments, the programming language includes a scripting type programming language. In certain embodiments, the programming language can include an analytics specific programming language (such as Statistica Visual Basic programming language available from Dell, Inc.) an R programming language, a Python programming language, etc. The data scientist 240 can also leverage automation capabilities in building and selecting a best model or the ensemble of models.

In general, the data scientist module 212 includes a selection of the data configuration component 242, a variable selection node component 244, and a semaphore node component 246. The semaphore node component 246 routes the analysis to analysis templates. In certain embodiments, the analysis templates include regression analysis templates, classification analysis templates and/or cluster analysis templates. In certain embodiments, only one of three links is enabled at a time.

The analysis templates may be modified via the data scientist module 212. In certain embodiments, modification of the analysis templates can include transformation operations, which can also include, data health check operations, feature selection operations, modeling node operations and model comparison node operations. Transformation operations can include business logic modifications, coarse coding, etc. The data health check operation verifies variability in a specific column, missing data in rows and columns, and redundancy (which can be strongly correlated columns that can cause multicollinearity issues). The feature selection operation selects a subset of input decision variables for a downstream analysis. The subset of input decision variables can depend on settings associated with the node on which the modifications are being performed. The modeling nodes operations perform the model building tasks specific for each particular analytic Workflow and application. Modeling tasks may include clustering tasks to detect groups of similar observations in the data, predictive classification tasks to predict the expected class for each observation, regression prediction tasks to predict for each observation expected values for one or more continuous variables, anomaly detection tasks to identify unusual observations, or any other operation that results in a symbolic or numeric equation to predict new observations based on repeated patterns in previously observed data. The model comparison node operations accumulate results and models which can then be used in the downstream reporting documents.

The data scientist module 212 includes a data scientist interface which is compatible with an end-user interface of the end-user module 210. The data scientist interface includes the ability to provide all configurations and customizations developed by the data scientist 240 to the end-user module 210.

Analytic workflows as designed and validated by the data scientist 240 are parameterized and published to the central repository 214. The analytic workflows 252 (e.g., Workflow 1) can then be recalled and displayed in the end-user module 210 via for example an end-user user interface 254. In the end-user module 210 only those parameters relevant to accomplish the desired analytic modeling tasks are exposed to the end-user 250, while the overall flow and flow logic is automatically enforced as designed by the data scientist.

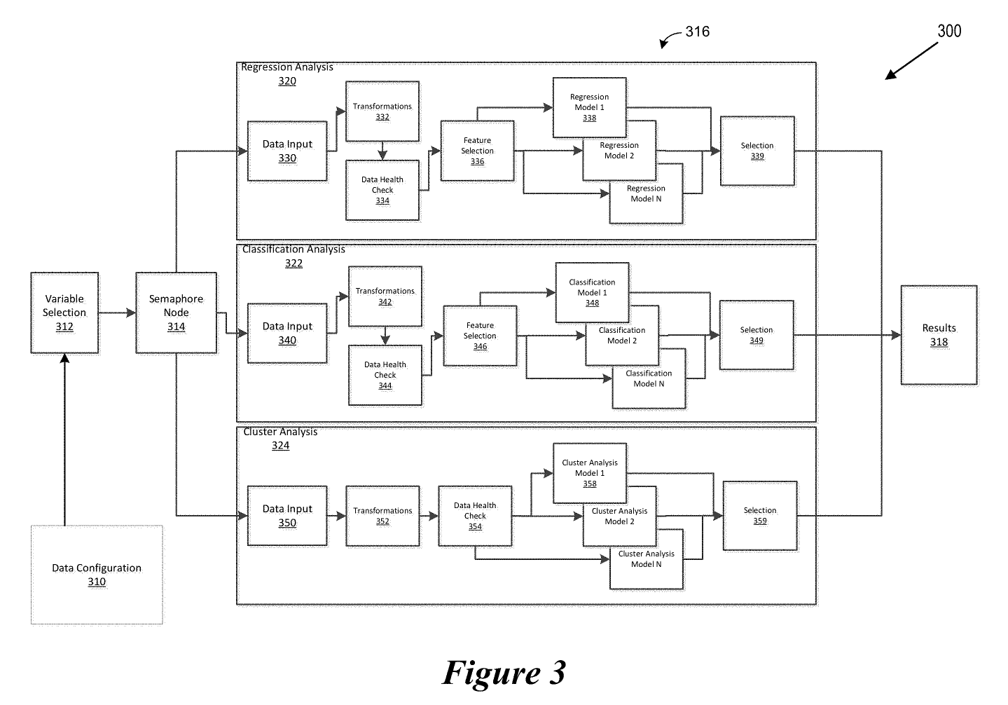

FIG. 3 shows a block diagram of data scientist facet 300 of the analytics workflow generation system. The data scientist facet 300 includes a data configuration component 310, a variable selection component 312, a semaphore node component 314, one or more analysis components 316, and a results component 318. The analysis components 316 include a regression analysis component 320, a classification analysis component 322 and/or a cluster analysis component 324. Some or all of the components of the data scientist facet 300 may be included within the data scientist module 212.

The semaphore node component 314 guides the analytic process to a specific group of subsequent analytic steps, depending on the characteristics of the analytic tasks targeted by a specific analytics workflow. If there is only a single analytic task targeted, for example a classification task, then the semaphore node may not be necessary or default to a single path for subsequent steps. The regression analysis component solves regression problems for modeling and predicting one or more continuous outcomes, the classification analysis component 322 models and predicts expected classifications of observations, and the cluster analysis component 324 clusters observations into groups of similar observations. Additional analysis components 316 may also be included, for example for anomaly detection to identify unusual observations in a group of observations, or dimension reduction to reduce large numbers of variables to fewer underlying dimensions. In certain embodiments, the regression analysis component 320, classification analysis component 322, and cluster analysis component 324 perform regression, classification and clustering tasks, respectively. Each task may be distinguished by what is being predicted. For example, the regression task might generate one or more measurements (e.g., a predicted yield, demand forecast, real estate pricing), the classification task might identify class membership probabilities (putting people or objects into buckets) based on historical information, and the clustering task might identify a cluster membership. In certain embodiments, with a cluster membership there is no outcome variable, as a clustering task may be considered unsupervised learning and clustering observations can be based on similarity.

In certain embodiments, the regression analysis component 320 provides one or more continuous outcome variables. In certain embodiments, the regression analysis component 320 includes a data input component 330, a transformations component 332, a data health check component 334, a feature selection component 336, one or more regression model components 338 (Regression model 1, Regression model 2, Regression model N) and a selection component 339. The data input component 330 verifies a selection of input variables for the model building process. For regression analysis tasks, the data input component 330 verifies that the outcome variable specified for the analysis (to be predicted) describes observed numeric values of the target variable or variables. In certain embodiments, when performing a regression analysis the input variables include variables with continuous values (i.e., continuous predictors). The transformations component 332 specifies suitable transformations identified by the data scientist expert depending on the nature of the analysis and selected variables; the transformation component 332 may perform recoding operations for categorical variables, continuous variables, or categorical variables, or apply continuous transformation functions to continuous variables or ranks. Other transformations may also be included in transformations component 332. The data health check component 334 checks the data for variability, missing data and/or redundancy within the data. The feature selection component 334 selects from among large numbers of input or predictor variables those that indicate the greatest diagnostic value for the respective analytic prediction task, as defined by one or more statistical tests. In this process, the feature selection component 334 may include logic to select for subsequent modeling only a subset of the features (variables) that go into the analytic flow. Each regression model component 328 provides a template for a particular regression model. The data scientist (e.g., data scientist 240) selects the best suitable classes of models and specifies criteria for the best model selection (e.g. R2, sum of squares error, etc.) based upon the analysis needs of a particular customer. The selection component 339 compares the models and selects a best fit model or an ensemble of models based upon the analysis needs of the particular customer. In case the template is run by the end-user, the model selection is performed automatically. Typical model selection criteria differ for regression, classification, etc. The data scientist is not limited to “a” model, but rather a class of models from which a model (or models) may be tested and selected.

In certain embodiments, the classification analysis component 322 provides a discrete outcome variable. The classification analysis component 322 includes a data input component 340, a transformations component 342, a data health check component 344, a feature selection component 346, one or more classification model components 348 (Classification model 1, Classification model 2, Classification model N) and a selection component 349. The data input component 340 verifies a selection of input variables for the model building process. For classification analysis tasks, the data input component 340 verifies that the outcome variable specified for the analysis (to be predicted) describes multiple observed discrete classes; input variables can include variables with continuous values (i.e., continuous predictors), categorical or discrete values (i.e., categorical predictors), or rank-ordered values (i.e., ranks). The transformations component 342 specifies suitable transformations identified by the data scientist expert depending on the nature of the analysis and selected variables; the transformation component 342 may perform recoding operations for categorical variables, continuous variables, or categorical variables, or apply continuous transformation functions to continuous variables or ranks. Other transformations may also be included in transformations component 342. The data health check component 344 checks the data for variability, missing data and/or redundancy within the data. The feature selection component 346 may include logic to select for subsequent modeling only a subset of the features (variables) that go into the analytic flow. Each classification model component 348 provides a template for a particular classification model. The data scientist (e.g., data scientist 240) selects the best suitable classes of models and specifies criteria for the best model selection (e.g. misclassification rate, lift, area under the curve (AUC), Kolmogorov-Smirnov statistic, etc.) based upon the analysis needs of a particular customer. The selection component 349 compares the models and selects a best fit model or an ensemble of models based upon the analysis needs of the particular customer.

In certain embodiments, the cluster analysis component 324 does not generate an outcome variable. The cluster analysis component 324 includes a data input component 350, a transformations component 352, a data health check component 354, a feature selection component 356, one or more cluster model components 358 (Cluster model 1, Cluster model 2, Cluster model N) and a selection component 359. The data input component 350 verifies a selection of input variables for the model building process. For cluster analysis tasks, the data input component 350 verifies that input variables can include variables with continuous values (i.e., continuous predictors), categorical or discrete values (i.e., categorical predictors), or rank-ordered values (i.e., ranks). Cluster analysis is usually unsupervised and doesn't require any target variable. Sometimes, a target variable can be used for labeling, but not training. The transformations component 352 specifies suitable transformations identified by the data scientist expert depending on the nature of the analysis and selected variables; the transformation component 352 may perform recoding operations for categorical variables, continuous variables, or categorical variables, or apply continuous transformation functions to continuous variables or ranks. Other transformations may also be included in transformations component 352. The data health check component 354 checks the data for variability, missing data and/or redundancy within the data. In certain embodiments, when performing a cluster analysis, no a-priori feature selection is available since there is no target variable. Each cluster model component 358 provides a template for a particular cluster model. The data scientist (e.g., data scientist 240) selects best suitable classes of models and specifies criteria for the best model selection (e.g. V-fold cross-validation, fixed number of clusters, etc.) based upon the analysis needs of a particular customer. The selection component 359 compares the models and selects a best fit model or an ensemble of models based upon the analysis needs of the particular customer.

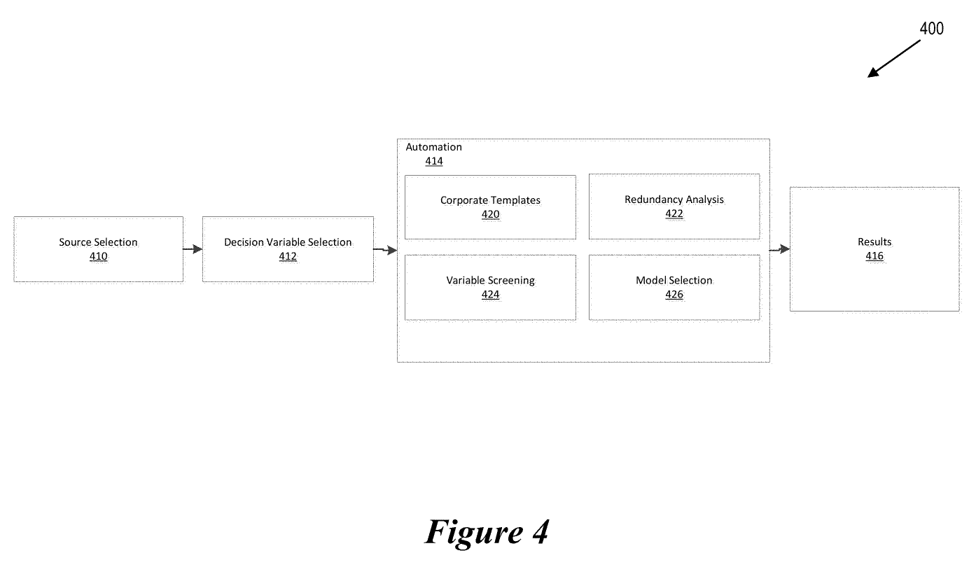

FIG. 4 shows a block diagram of an end-user facet 400 of the analytics workflow generation system. The end-user facet 400 automatically identifies an analysis operation given selected data source and decision variables. In certain embodiments, the selected data source and decision variables can include specification of the inputs and target(s). Target variables are not necessarily required for clustering tasks, where observations are grouped based on similarity computed from the selected input variables only.

The end-user facet 400 includes a source selection component 410, a decision variable selection component 412, an automation component 414 and a results component 416. Some or all of the components of the end-user facet 400 may be included within the end-user module 210. The source selection component 410 enables an end-user (e.g., end-user 250) to select a source of the data to be analyzed. In certain embodiments, a plurality of sources may be selected. The variable selection component enables an end-user to select decision variables. In certain embodiments, only inputs and targets are selected by the end-user, variable types are identified automatically based upon the templates provided by the data scientist. The results component 416 enables an end-user to perform one or more of a plurality of results operations. The results operations can include a save results operation, a deploy results operation, a review models operation, and/or a present results operation.

The automation component 414 can include one or more of a plurality of automation modules. In certain embodiments, the automation modules can include a corporate templates module 420, a redundancy analysis component 422, a variable screening component 424 and/or a model selection component 426. The corporate templates component 420 automatically applies corporate templates when performing the analysis operation. The redundancy analysis component 422 automatically reviews redundancy analysis results. The variable screening component 424 automatically reviews variable screen results. The model selection component 426 automatically selects a model or modeling algorithm from a plurality of available models or modeling algorithms (developed by a data scientist) based upon a desired analysis of the end-user. In certain embodiments, data source selection is only from available data configurations or data files. In certain embodiments, when performing a decision variables selection operation variable types are detected automatically based on variable properties such as a type of variable, a text label of a variable, a number of unique values within the variable type.

In certain embodiments, an end-user can select multiple target variables, which results in automated branching of the downstream steps into parallel flows, one per each target variable. For example, if the end-user customer were oil well completion optimization, the multiple target variables might include three variables: production over the first 30 days, total expected production and oil to water ratio.

In certain embodiments an end-user can select from any of a plurality of templates for analyses. This enables the end-user to fine-tune data preparation steps and analyses settings to the organizational needs and specifics of the data. In certain embodiments, the end-user can add custom and/or crowd-sourced (including R-based) nodes for data transformation and analytics.

In certain embodiments, the end-user can review the results of redundancy analysis and make manual decisions about variables included in the customer specific analysis. In certain embodiments, the end-user can review variable screening results (e.g., via a variable screening result user interface) and can make a manual decision about variables to be included in the analysis. In certain embodiments, the end-user can review and select a list of analytic models to be used. Selecting a particular list of models to be used can be helpful when duration of the analysis is important.

When executing the analysis, the end-user facet 400 automatically performs data preparation operations, feature selection operations, etc. Also, when executing the analysis, the end-user facet accumulates intermediate results for use within a final report. Also, when executing the analysis, data is automatically retrieved from the data repository to the analyses. In certain embodiments, the data that is automatically retrieved is the data necessary to provide a best model of each kind of model and to compare different kinds of models (e.g. data for decision trees, neural networks, etc.). Also, when executing the analysis, if multiple target variables are selected, then the steps of the analysis are repeated for each target.

After the analysis is executing, the end-user is presented with a report on the analysis and best model(s) generated. The user can store the work project itself that can be later opened either with end-user facet 400 or with a data scientist facet 300.

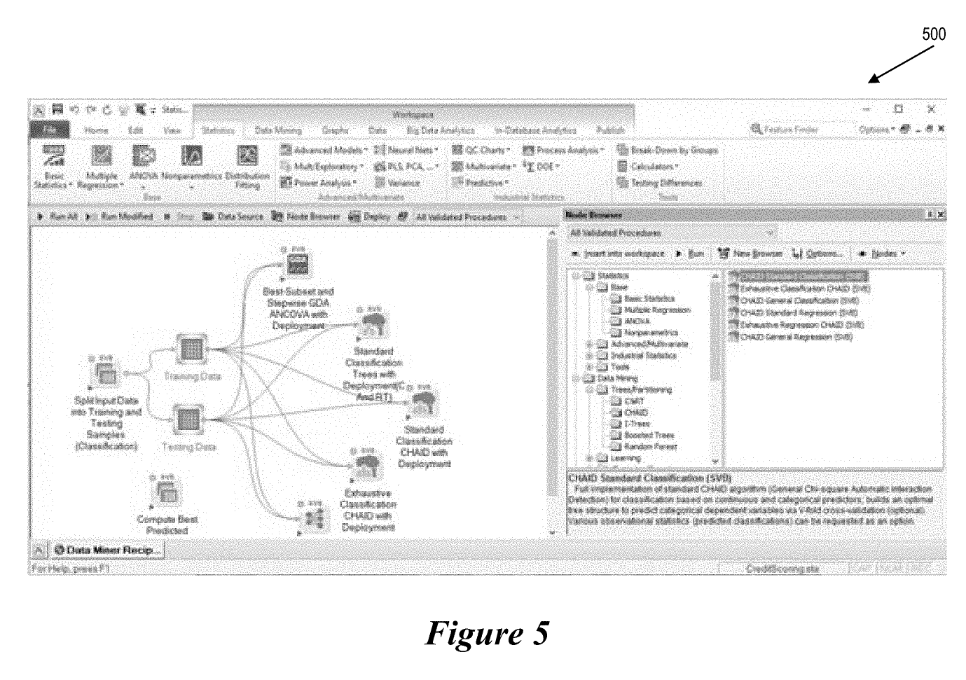

FIG. 5 shows an example screen presentation of an expert data scientist user interface 500. The expert data scientist user interface 500 provides a user interface for the expert data scientist to create a workflow. In certain embodiments, the user interface 500 enables the expert data scientist to access templates when creating the workflow.

In certain embodiments, the user interface 500 is flexible to permit data scientists to select data management and analytical tools from a comprehensive palette, to parameterize analytic workflows, to provide the self-service business users the necessary flexibility to address the particular challenges and goals of their analyses, without having to understand data preparation and modeling tasks.

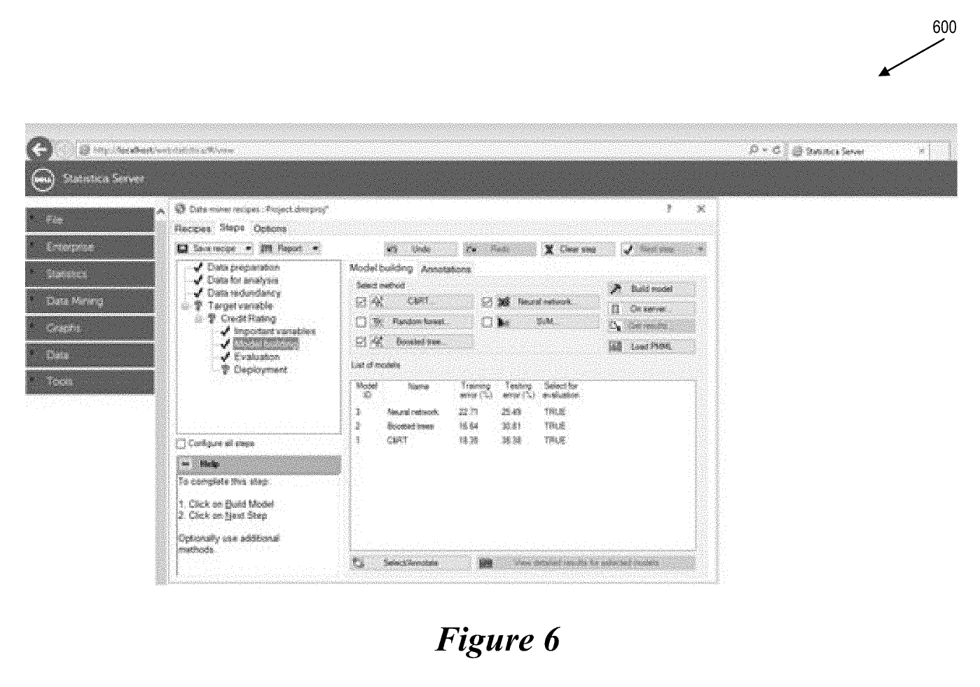

FIG. 6 shows an example screen presentation of a self-service end-user user interface 600. The self-service end-user user interface 600 provides a user interface (which may be web based) for citizen data scientists to easily create a workflow. In certain embodiments, the user interface 600 enables data modelers and data scientists to generate parameterized analytic templates. In certain embodiments, the parameterized analytic templates include one or more of data preparation, data modeling, model evaluation, and model deployment steps specifically optimized for a particular domain and data sets of interest.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, it will be appreciated that the high dimensional input parameter spaces in-database using common queries that can be executed in parallel in-database, to derive quickly and efficiently a subset of diagnostic parameters for predictive modeling can be especially useful in large data structures such as data structures having thousands and even tens of thousands of columns of data. Examples of such large data structures can include data structures associated with manufacturing of complex products such as semiconductors, data structures associated with text mining such as may be used when performing warranty claims analytics as well as when attempting to red flag variables in data structures having a large dictionary of terms. Other examples can include marketing data from data aggregators as well as data generated from social media analysis. Such social media analysis data can have many varied uses such when performing risk management associated with health care or when attempting to minimize risks of readmission to hospitals due to a patient not following an appropriate post-surgical protocol.

Consequently, the invention is intended to be limited only by the spirit and scope of the appended claims, giving full cognizance to equivalents in all respects.

What is claimed is:

1. A computer-implementable method for performing an analytics workflow generation operation, comprising:
providing an analytics workflow generation system, the analytics workflow generation system comprising an analytics workflow user interface;
generating a targeted parameterized analytics template via the analytics workflow user interface, the targeted parameterized analytics template being customized for a particular customer based upon analytics needs of the customer;
publishing the targeted analytics workflow to a workflow storage repository.

2. The method of claim 1, further comprising:
retrieving the targeted parameterized analytics template from the workflow storage repository, the retrieving being performed by an end-user associated with the customer to solve a specific analytics need of the customer.

3. The method of claim 1, wherein:
the parameterized analytic template comprises at least one of a data preparation analytic template, a data modeling analytic template, a model evaluation analytic template, and a model deployment analytic template.

4. The method of claim 1, wherein:
the parameterized analytic template comprises steps specifically optimized for a particular domain and data sets of interest.

5. The method of claim 1, wherein:
an end-user user interface enables an end-user select data management and analytical tools from a comprehensive palette, to parameterize analytic workflows, to provide the self-service business users flexibility to address the particular needs of the customer without having to understand data preparation and modeling tasks.

6. The method of claim 5, wherein:
the end-user interface accommodates role-based authentication so particular groups of end-users have access to relevant templates to solve analytic problems of a domain of the particular group of end-users.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an analytics workflow generation system, the analytics workflow generation system comprising an analytics workflow user interface;
generating a targeted parameterized analytics template via the analytics workflow user interface, the targeted parameterized analytics template being customized for a particular customer based upon analytics needs of the customer;
publishing the targeted analytics workflow to a workflow storage repository.

8. The system of claim 7, wherein the instructions are further configured for:
retrieving the targeted parameterized analytics template from the workflow storage repository, the retrieving being performed by an end-user associated with the customer to solve a specific analytics need of the customer.

9. The system of claim 7, wherein:
the parameterized analytic template comprises at least one of a data preparation analytic template, a data modeling analytic template, a model evaluation analytic template, and a model deployment analytic template.

10. The system of claim 7, wherein:
the parameterized analytic template comprises steps specifically optimized for a particular domain and data sets of interest.

11. The system of claim 7, wherein:
an end-user user interface enables an end-user select data management and analytical tools from a comprehensive palette, to parameterize analytic workflows, to provide the self-service business users flexibility to address the particular needs of the customer without having to understand data preparation and modeling tasks.

12. The system of claim 11, wherein:
the end-user interface accommodates role-based authentication so particular groups of end-users have access to relevant templates to solve analytic problems of a domain of the particular group of end-users.

13. A non-transitory, computer-readable storage medium embodying computer program code, the computer program code comprising computer executable instructions configured for:
providing an analytics workflow generation system, the analytics workflow generation system comprising an analytics workflow user interface;
generating a targeted parameterized analytics template via the analytics workflow user interface, the targeted parameterized analytics template being customized for a particular customer based upon analytics needs of the customer;
publishing the targeted analytics workflow to a workflow storage repository.

14. The non-transitory, computer-readable storage medium of claim 13, wherein the instructions are further configured for:
retrieving the targeted parameterized analytics template from the workflow storage repository, the retrieving being performed by an end-user associated with the customer to solve a specific analytics need of the customer.

15. The non-transitory, computer-readable storage medium of claim 13, wherein:
the parameterized analytic template comprises at least one of a data preparation analytic template, a data modeling analytic template, a model evaluation analytic template, and a model deployment analytic template.

16. The non-transitory, computer-readable storage medium of claim 13, wherein:
the parameterized analytic template comprises steps specifically optimized for a particular domain and data sets of interest.

17. The non-transitory, computer-readable storage medium of claim 13, wherein:
an end-user user interface enables an end-user select data management and analytical tools from a comprehensive palette, to parameterize analytic workflows, to provide the self-service business users flexibility to address the particular needs of the customer without having to understand data preparation and modeling tasks.

18. The non-transitory, computer-readable storage medium of claim 17, wherein:
the end-user interface accommodates role-based authentication so particular groups of end-users have access to relevant templates to solve analytic problems of a domain of the particular group of end-users.
